(19) United States
(12) Patent Application Publication
(10) Pub. No.: US 2016/0292743 A1
(43) Pub. Date: Oct. 6, 2016

(54) MOBILE COMPUTING DEVICE ADVERTISEMENT POSITIONING AND DYNAMIC REPOSITIONING

(71) Applicant: INMOBI PTE LTD., Singapore (SG)

(72) Inventors: Amit Deshpande, Belgaum (IN); Amal Tiwari, Bangalore (IN)

(73) Assignee: INMOBI PTE LTD., Singapore (SG)

(21) Appl. No.: 14/828,989

(22) Filed: Aug. 18, 2015

Related U.S. Application Data
(60) Provisional application No. 62/141,899, filed on Apr. 2, 2015.

(51) Int. Cl. G06Q 30/02; G06F 3/0486; G06F 3/0484

(52) U.S. Cl. CPC G06Q 30/0267; G06F 3/04842; G06F 3/0486

(57) ABSTRACT

A system and method transform a mobile computing device into a machine that displays multiple advertisements on a screen of the mobile computing device with at least one of the advertisements having a prominent position on a screen of the mobile computing device and the remaining, viewable advertisements having subordinate positions on the screen. In at least one embodiment, a subordinate position occupies less screen space than the prominent position. In at least one embodiment, displaying multiple advertisements allows the mobile computing device to engage the user with multiple advertisements, thus, increasing the likelihood that the user will act on at least one of the advertisements. Furthermore, the system and method further transform the mobile computing device into a machine that allows the user to reposition the advertisements by reallocating the prominent and subordinate positions to different advertisements.

### BACKGROUND OF THE INVENTION

1. Field of the Invention

The present invention relates in general to the field of electronics, and more specifically to a system and method for mobile computing device advertisement positioning and dynamic repositioning.

2. Description of the Related Art

Mobile computing devices have gained world-wide recognition as a convenient and efficient platform to perform a variety of functions and interact with other devices via an electronic network. Mobile computing devices often include multiple instances of application software, commonly referred to as a “mobile app” or simply “app.” Unless otherwise clearly indicated, the terms “mobile app” and “app” are used interchangeably to refer to application software developed for and/or executable on a mobile computing device. Mobile communication devices execute apps to provide at least some of the variety of the functions for users of the mobile computing devices. Apps are usually either included from the original equipment manufacturer of the mobile computing device or are available through various application distribution platforms such as the Apple App Store, Google Play, Windows Phone Store, Amazon App Store, Nokia Store, Samsung Apps Store, and Blackberry App World. Exemplary apps include telephone general productivity and informational, such as email, calendar, contacts, news, weather, and word processing and other categories such as social media, data sharing, games, mapping, banking, streaming, medical, etc.

Apps are often free to users for downloading to the user's mobile computing device via a distribution platform or are sold for a relatively small amount of money. To generate revenue, an mobile apps often rely on revenue from advertisements (“ads”) presented via the app.

FIG. 1 depicts an exemplary ad serving environment 100 that includes a mobile computing device 102 that interacts with an ad server network 104 to obtain an ad 106. The mobile computing device 102 includes a processor 108 that executes the app 110 stored in the memory 112. The processor 108 executes the app 110, and the app 110 performs a programmed function that allocates space 117 on screen 116 to display image 118. The image 118 can be static or dynamic and includes static or dynamic graphics, video, text, or any other type of multimedia and can be associated with audio. The app 110 also includes ad request code 119 that when executed by the mobile computing device 102 causes the mobile computing device 102 to make an ad request 120 to the ad server network 104. The ad server network 104 receives the ad request 120 and either directly or indirectly through an ad content distributor (not shown) generates or obtains ad data 122 from the ad data collection 124. The configuration and particular ad server network 104 is a matter of design choice and is, for example, an ad server network provided by InMobi, Ltd having offices in, for example, Bangalore, India and New York, N.Y., USA.

The mobile computing device 102 receives and then renders and displays the ad data 122 as ad image 126 in the allocated ad space 128 of screen 116. The ad image 126 presents a single advertisement. A user of the mobile computing device 102 can select the ad image 126 via a detected tap or gesture, but, otherwise, the ad image 126 is not interactive with the user.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 (labeled prior art) depicts an exemplary ad serving environment.

FIG. 2 depicts a mobile communication system that includes a mobile computing device with advertisement position/reposition code to transform a screen of the mobile computing device.

FIG. 3 depicts an exemplary instantiation cycle of an application software.

FIG. 4 depicts an exemplary advertisement acquisition and user interaction process.

FIGS. 5-7 depict advertisement position/reposition code pseudocode.

FIGS. 8-11 depict exemplary advertisements displayed on a screen of an exemplary mobile computing device.

### DETAILED DESCRIPTION

A system and method transform a. mobile computing device into a machine that displays multiple advertisements on a screen of the mobile computing device with at least one of the advertisements having a prominent position on a screen of the mobile computing device and the remaining, viewable advertisements having subordinate positions on the screen. In at least one embodiment, a subordinate position occupies less screen space than the prominent position. The number of concurrently displayed prominent and subordinate positions, and, thus, the number of concurrently displayed advertisements is a matter of design choice. In at least one embodiment, displaying multiple advertisements allows the mobile computing device to engage the user with multiple advertisements, thus, increasing the likelihood that the user will act on at least one of the advertisements. Furthermore, the system and method further transform the mobile computing device into a machine that allows the user to reposition the advertisements by reallocating the prominent and subordinate positions to different advertisements. The particular relative orientations of the prominent and subordinate positions and, thus, the display of the advertisements is a matter of design choice.

In at least one embodiment, the mobile computing device displays advertisements as graphic cards. The graphic cards can be of any physical size or shape and can contain any combination of text, graphics, video, animation, and/or other multimedia types and can include associated audio data.

In at least one embodiment, the mobile computing device detects an interaction with the mobile computing device by a user. The mobile computing device interprets the interaction to determine if the interaction indicates a request to reposition the advertisements that are displayed. When the interaction is interpreted to indicate the request to reposition the displayed advertisements, a processor and screen controller of the mobile computing device in accordance programming in the mobile computing device, transform the display of the mobile computing device to reposition the advertisements on the screen. In at least one embodiment, the user can interact with the mobile computing device to reposition the advertisements any number of times. In at least one embodiment, the user controls a mode of dynamic repositioning. For example, in at least one embodiment, the advertisements are shuffled from front to back, side-to-side, up and down, rotating the advertisements around one or more fixed points, or any other mode of dynamic repositioning. In at least one embodiment, the mode is controlled by interpreting a motion indicated by a user's gestures with respect to the advertisements. In at least one embodiment, the mode of repositioning is fixed so that user interaction with the advertisements results in only one mode of repositioning.

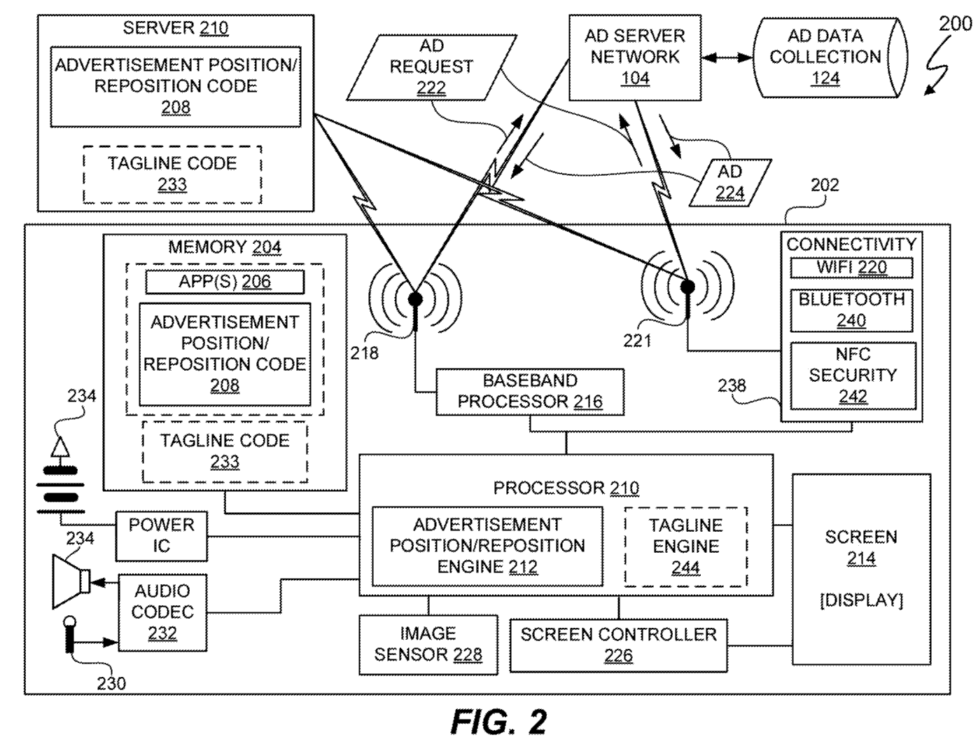

FIG. 2 depicts a mobile communication system 200 that includes a mobile computing device 202 with advertisement position/reposition code that transforms the mobile computing device 202 into a machine that concurrently displays multiple advertisements and repositions the multiple advertisements following a repositioning command event. The mobile computing device 202 is any type of device that is mobile and can be connected to the Internet. Exemplary mobile computing devices are mobile smart phones (such as the Apple iPhone and phones available from Samsung, LG, Motorola, HTC, and Huawei Samsung), tablet computers (such as the Apple iPad, Microsoft Surface, and Samsung Galaxy). The mobile computing device 202 includes a memory 204, which is a non-transitory, computer readable medium that can be a volatile, non-volatile, or a combination of volatile and non-volatile type storage. The memory 204 also includes one or more mobile application software programs (“app”) 206 that when executed by a processor 208 allow the mobile computing device 202 to provide a variety of functions for a user of the mobile computing device 202. The method(s) of obtaining app(s) 206 is(are) a matter of design choice. App(s) 206 are, for example, preloaded into the memory 204 by, for example, an original equipment manufacturer and/or downloaded from one or more application distribution platforms as previously described.

Memory 204 also includes advertisement position/reposition code 208. The advertisement position/reposition code 208 can be included as part of the code of one or more of the apps 206 and stored in a memory space of one or more apps 206 and/or can be separate from one or more of the apps 206 and stored in, for example, a general memory space of memory 204. When separate from the apps 206, the advertisement position/reposition code 208 is, for example, written and installed as native or interpreted code of the mobile computing device 202.

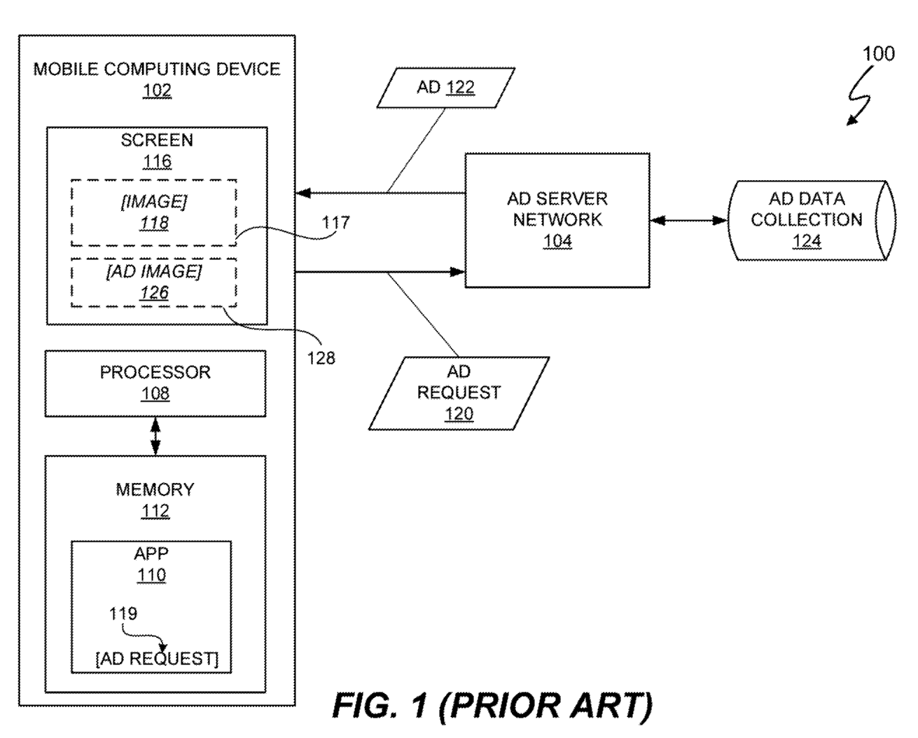

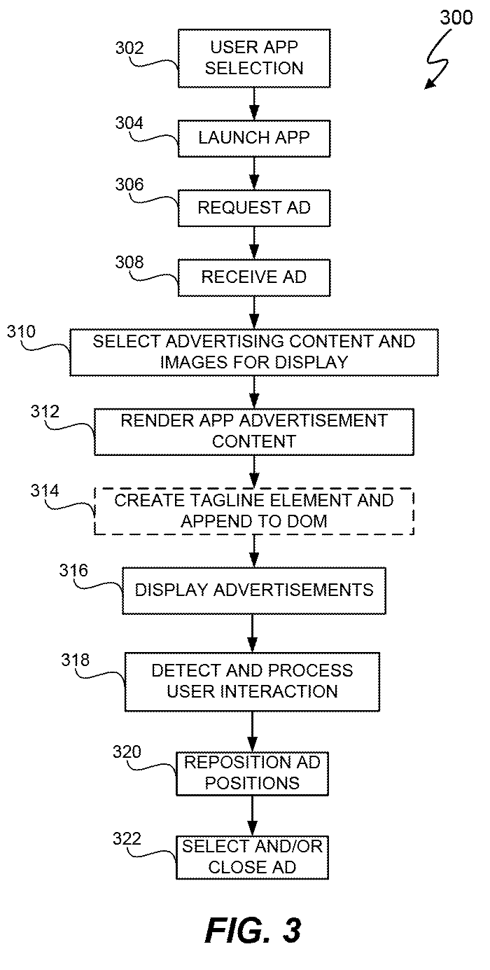

FIG. 3 depicts an exemplary instantiation cycle 300 of an app, such as app 206, and advertising content. Referring to FIGS. 2 and 3, in operation 302, a user of the mobile computing device 202 selects one of app(s) 206 for execution by the processor 210 by, for example, using a gesture to indicate selection of the app 206, such as touching a. portion of the screen containing an icon of the selected app 206. In operation 304, the mobile computing device 202 launches (executes) the selected app. To launch the selected app 206, the processor 210 accesses the memory 204 and executes an app 206 and advertisement position/reposition code 208. When the processor 210 executes the app 206 and advertisement position/reposition code 208, the processor 206 is transformed to include an advertisement position/reposition engine 212. In at least one embodiment, the advertisement position/reposition engine 212 represents the processor 210 as transformed in the execution of the advertisement position/reposition code 208. Thus, in at least one embodiment, the advertisement position/reposition engine 212 performs the circuit functions corresponding to the instructions of the advertisement position/reposition code 208. The app 206 includes ad request code, such as ad request code 119 (FIG. 1) that when executed causes the processor 210 to request advertisement content and allocate display space on screen 214. Screen 214 represents an externally visible screen of mobile computing device 202. In operation 306, the advertisement content request 222 causes the mobile computing device 202 to request the advertising content 224 from the ad server network 104. In at least one embodiment, the request 222 for advertising content 224 initiated by the executing app 206 causes the processor 210 to wirelessly contact the ad server network 104 via the baseband processor 216 when using cellular data coverage or through a Wi-Fi component 220 when using a local area wireless access network. In at least one embodiment, the baseband processor 216 is a device that manages radio traffic communications through antenna 218, and the Wi-Fi component 220 manages communication to either a wireless network access point via antenna 221 or via a wired connection (not shown).

In operation 308, the ad server network 104 returns the requested advertisement content to the mobile computing device 202 for processing by the advertisement position/reposition engine 212. The received advertising content 222 includes data to display N advertisements, wherein N is an integer representing a quantity of advertisements included in the advertising content 222. Before the advertising content 222 is rendered by the advertisement position/reposition engine 212, the screen 214 displays a first user interface that is a matter of design choice as, in at least one embodiment, determined by the executing app 206 and the mobile computing device 202. In operation 310, the advertisement position/reposition engine 212 selects the advertising content 222 and corresponding images for rendering and display by screen 214. In operation 312, when the advertisement position/reposition engine 212 renders the advertising content 222, the advertisement position/reposition engine 212 transforms the displayed first user interface on the screen 214 into a second user interface.

In at least one embodiment, the memory 204 also includes tagline code 233, which can, for example, be downloaded from server 210 and installed in memory 204 or installed in memory 204 by a user or original equipment manufacturer of mobile computing device 202. In operation 314, the optional tagline code 233 when executed by the processor 210 creates a tagline engine 244. The tagline engine 244 allocates space on the screen 214 to display a tagline element. The tagline element can include prestored information in memory 204, can include information retrieved from a remote server (not shown), and can be a combination of prestored information and information retrieved from the remote server. For example, the tagline can include information, such as usage trend information, total number of user information, and rating information, for a product or service represented by any of the displayed advertisements. In at least one embodiment, the app 206 includes hypertext markup language (HTML) code to define the app 206 and provide physical details for rendering. In at least one embodiment, the tagline element is appended to a hypertext markup language document object model (DOM) of the app 206. Exemplary taglines are discussed subsequently.

In operation 316, advertisement position/reposition code 208 arranges the rendered advertising content for display on the screen 214. In at least one embodiment, the transformation from the first interface into the second interface includes rendering the advertising content 222 to display a first of the N advertisements in a prominent position on the screen 214 and to display second through M advertisements in subordinate positions relative to the first of the advertisements. M is an integer greater than one and less than or equal to N. Exemplary interfaces are subsequently described. The prominent position can be demarcated from the subordinate positions in any number of ways, such as the prominent position occupying more screen space that the subordinate positions either individually or collectively, color prominent position and black & white subordinate positions, animated prominent position versus non-animation of subordinate positions, text based indications of prominent and subordinate, selectability, for example only the ad in the prominent position can be selected. In at least one embodiment, at least a portion of the advertising content 222 is stored in and retrieved from memory 204 and, thus, a wireless request for advertising content 222 is not performed.

As subsequently described in additional detail, in at least one embodiment, a position is the prominent position relative to subordinate positions by being the most visibly conspicuous or by being defined as the prominent position in the advertisement position/reposition code 208. In at least one embodiment, an advertisement position is the prominent position relative to the remaining subordinate positions by, for example, occupying more screen space than any one subordinate position, having color graphics versus black and white for the subordinate positions, including animated graphics versus static graphics, including an indication of rank or other identification as the advertisement in the prominent position, and/or the only advertisement that is selectable occupies the prominent position.

The advertisement position/reposition engine 212 allows the advertisements to exchange prominent and subordinate positions so that different advertisements can rotate from being in a subordinate position to eventually occupying the prominent position. The number of concurrently displayed advertisements M is equal to the number of advertisements N when the all of the N advertisements occupy a prominent or subordinate position. M is less than N when one or more of the N advertisements are not concurrently displayed with all the remaining advertisments, but advertisement position/reposition engine 212 can still rotates all N advertisements into prominent positions.

How and when the advertisements are selected to exchange positions as displayed on the screen 214 is a matter of design choice. In at least one embodiment, in operation 318, the mobile computing device 202 detects an interaction with the screen 214 by a user (not shown) of the mobile computing device 202. The interaction occurs, for example, when the user makes physical contact with the screen 214 via, a gesture. such as a single or multiple finger tap, slide, or drag, that is detected by the screen controller 226. In at least one embodiment, the interaction includes non-contact interactions such as motion gestures detected by image sensor 228 or audio commands detected by microphone 230 and digitally coded by audio codec 232. The processor 210 interprets the detected interaction to determine if the interaction indicates a request to reposition the advertisements that are displayed. In operation 320, when the interaction is interpreted to indicate the request to reposition the displayed advertisements, as subsequently discussed, the advertisement position/reposition engine 212 transforms the second user interface displayed on the screen 214 into a third user interface that displays a repositioning of at least the M advertisements and repositions the advertisements to display a second of the N advertisements occupying the prominent position on the screen relative to the remaining advertisements. The advertisement position/reposition engine 212 can continue to detect user interactions with the mobile computing device 202 and continue to transform the user interface displayed by screen 214 into a display that displays a repositioning of at least the M advertisements and repositions the advertisements to change which of the N advertisements occupies the prominent position on the screen relative to the remaining advertisements and which of the M advertisements occupies the subordinate positions. In at least one embodiment, the advertisement position/reposition engine 212 responds to user interaction with the advertisements and includes code to automatically reposition the advertisements. A particular prompt or trigger for automatic repositioning is a matter of design choice, such as automatic repositioning after a predetermined amount of elapsed time.

In operation 322, the user interacts with the displayed advertisement and, in at least one embodiment, either selects the advertisement or closes the advertisement. In operation 322, the user interacts with the displayed advertisement and, in at least one embothment, either selects the advertisement or closes the advertisement. The screen controller 226 detects and the processor 210 interprets the user interaction to determine if the interaction indicates a selection of a displayed advertisement. When the interaction indicates a selection of a displayed advertisement, in at least one embodiment, the processor 210 via the baseband processor 216 sends a request for data to a server computer (not shown) referenced by, for example, a URL in the advertisement code and then receives the requested data from the server computer. The requested data generally includes executable code, such as HTML, that renders information about the product or service contained in the advertisement, presents a more detailed advertisement, or links to an ecommerce site to purchase the product or service.

In at least one embodiment, the advertisement position/reposition code 208 includes scaffolding code to provide directions to the user of the mobile computing device 202 on how to interact and manipulate the multiple advertisements. Exemplary “scaffolding code” instructs the user to “Swipe up for more” which when followed, provides a visual animation displayed on the screen 214 that results in more advertisement images appearing from the bottom of the screen 214 and cards being repositioned within the prominent and subordinate positions. Other embodiments of scaffolding code allow a user to, for example, shuffle advertisements in circular or arc rotations, side to side, in random display patterns, etc.

The mobile computing device 202 includes other exemplary components, such as battery 234 that provides operational power and speaker 236 converts audio signals into sound. In addition to the Wi-Fi component 220, connectivity circuitry 238 includes Bluetooth module 240 that allows the mobile computing device 202 to wirelessly exchange data with other devices via, the bluetooth wireless technology standard. Connectivity circuitry 238 also includes near field communication (NFC) technology 242 that allows mobile computing device 202 to communicate via radio communication with other devices equipped with NEC technology.

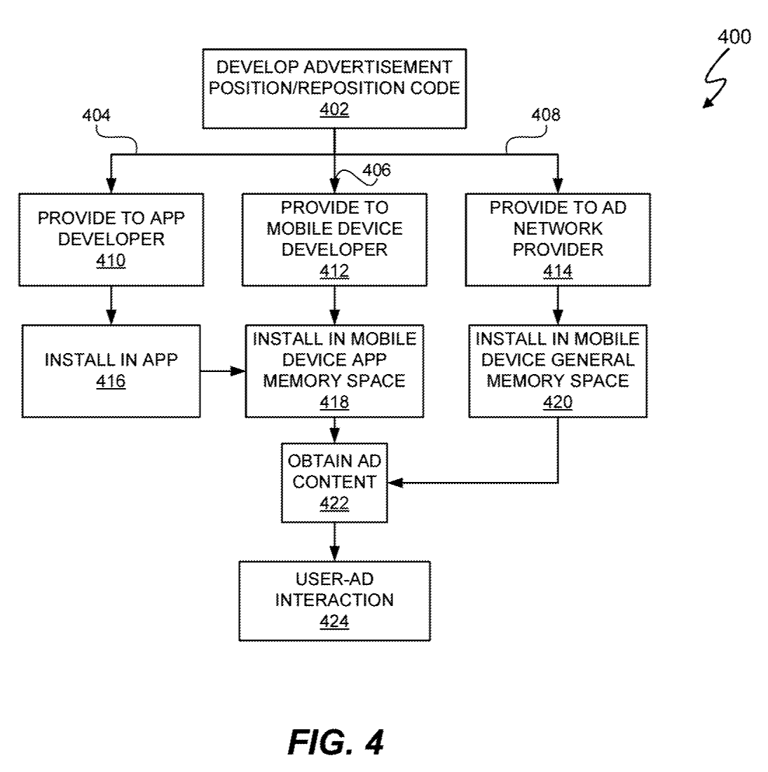

FIG. 4 depicts an exemplary advertisement acquisition and user interaction process 400. In operation 402, one or more developers develop the advertisement position/reposition code 208. The advertisement position/reposition code 208 is made available via, one or more channels, such as a via channels 404, 406, and 408. Each channel 404, 406, and 408 represents a means of providing the advertisement position/reposition code 208 and includes physical access to a mobile computing device and the memory therein, transfer of the advertisement position/reposition code 208 via a network, such as the Internet, and/or transfer via a non-transitory computer readable medium such as a flash drive, digital versatile disk (DVD), or compact disk (CD). In operation 410, the advertisement position/reposition code 208 is provided via channel 404 to an app developer. In operation 412, the advertisement position/reposition code 208 is provided to a mobile computing device developer or manufacturer, and in operation 414, the advertisement position/reposition code 208 is provided to an advertising network provider. In operation 416, the app developer installs the advertisement position/reposition code 208 into an app, and operation 418 installs the app with the advertisement position/reposition code 208 in the memory space of the mobile computing device. In operation 420 and generally in response to a manually initiated or automatic request from a mobile computing device, the ad network provider provides the advertisement position/reposition code 208 to a mobile computing device, and the advertisement position/reposition code 208 is installed in the general memory space of the mobile computing device. Operation 422 obtains advertising content, such as advertising content 224 as, for example, previously described. In operation 424, a user interacts with advertising content displayed on the mobile computing device to reposition the advertising content as, for example, previously described.

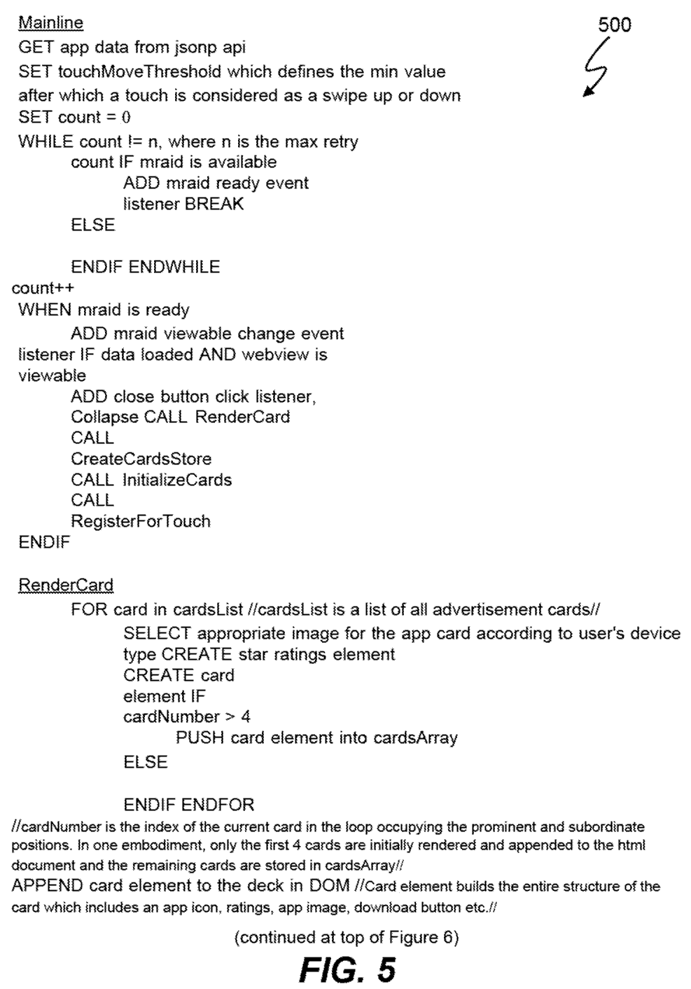

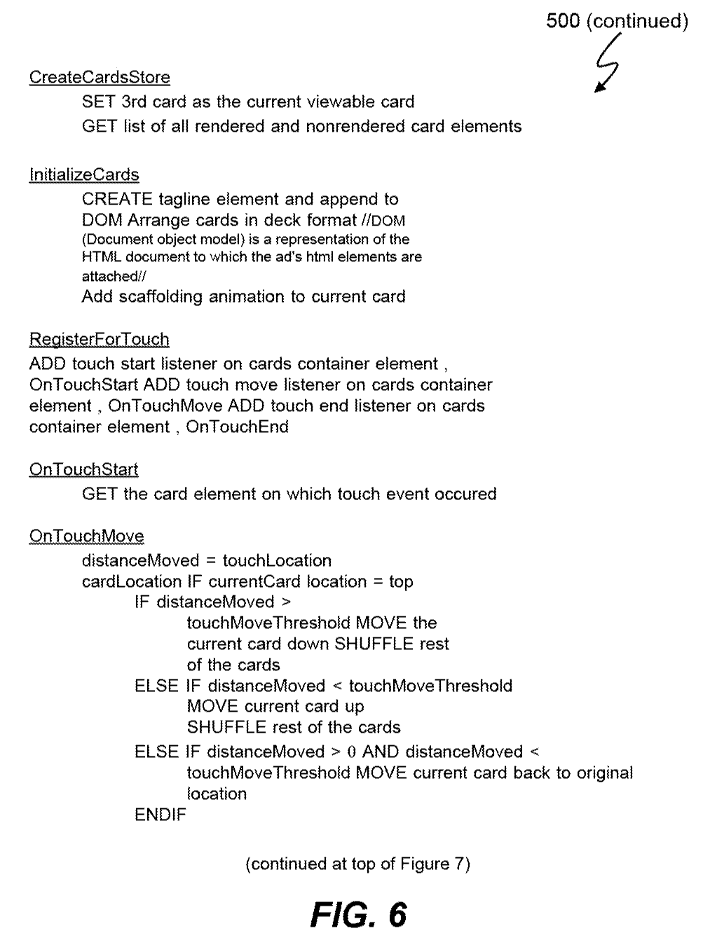

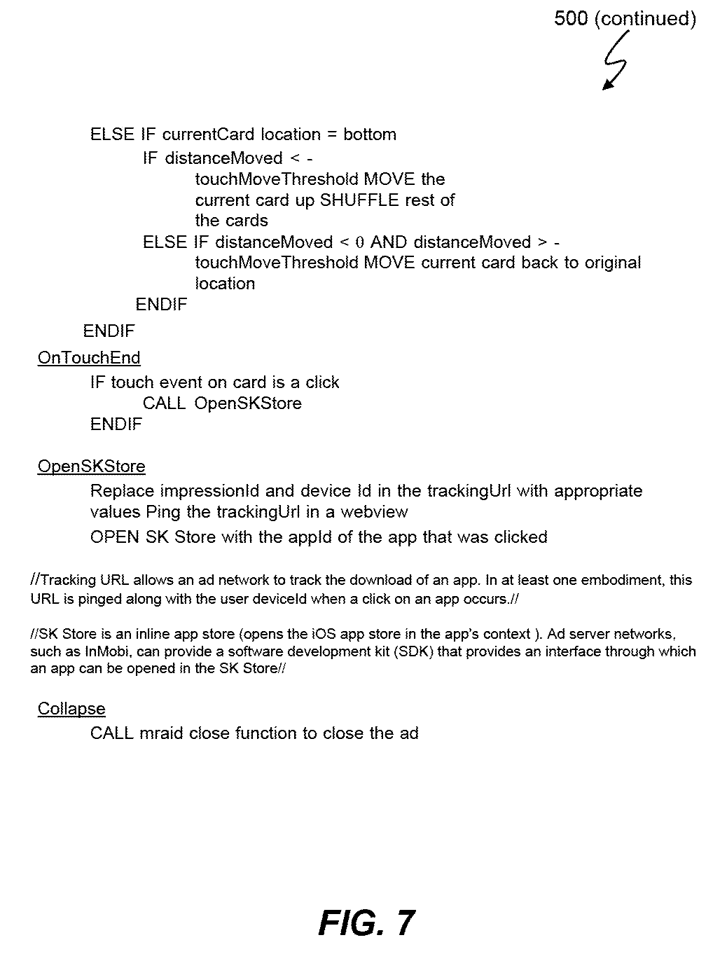

FIGS. 5-7 depict advertisement position/reposition code pseudocode 500, which represents one embodiment advertisement position/reposition code 208. Comments are delineated with double forwarded slashes “//”.

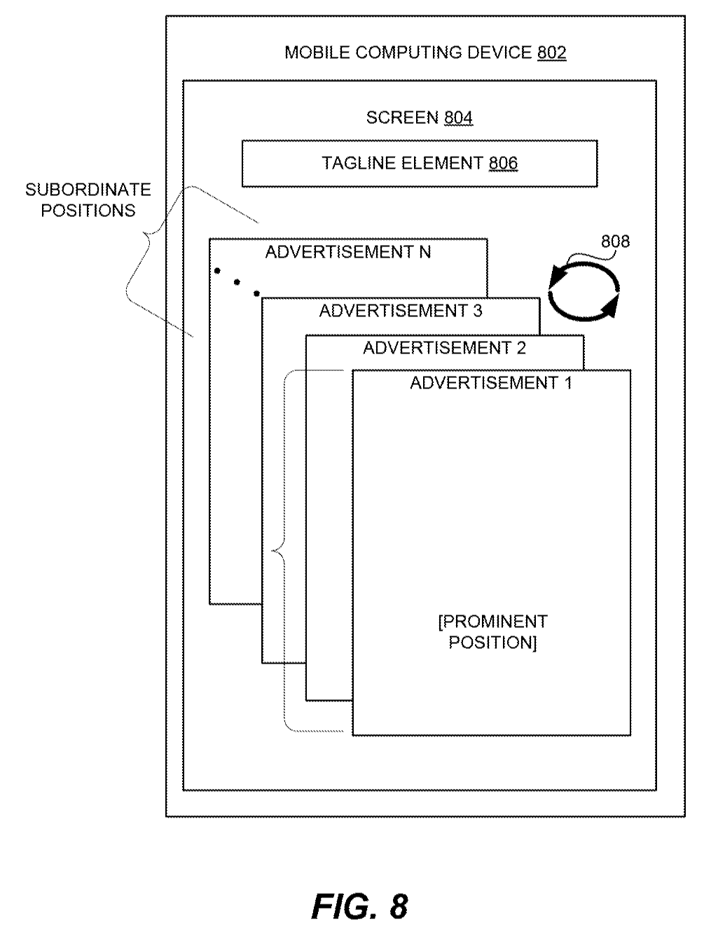

FIGS. 8-11 depict exemplary advertisements displayed on a screen of an exemplary mobile computing device. Referring to FIG. 8, mobile computing device 802 represents one embodiment of mobile computing device 202 and includes screen 804, which represents one embodiment of screen 214. The advertisement position/reposition engine 212 transforms the screen 804 to display the tagline element 806 and N advertisements ADVERTISEMENT 1-ADVERTISEMENT N. ADVERTISEMENT 1 occupies the prominent position, and ADVERTISEMENTS 2-N occupy subordinate positions. “N” is an integer representing the number of displayed advertisements. The rotation symbol 808 represents one embodiment of repositioning the ADVERTISEMENT 1-ADVERTISEMENT N. In at least one embodiment, the rotation symbol 808 serve as a visualization of how the advertisements will be repositioned and entices the user of mobile computing device 802 to interact with the scaffolding 808 and, thus. ADVERTISEMENT 1-ADVERTISEMENT N. In at least one embodiment, the rotation symbol 808 can be selected by user interaction with the screen 804 to cause the advertisement position/reposition engine 212 to rotate the ADVERTISEMENTS 1-N in order to reposition the advertisements. Thus, in at least one embodiment, when a user interacts with screen 804 and the interaction is detected and interpreted as a request to reposition ADVERTISEMENT 1-ADVERTISEMENT N, the advertisement position/reposition engine 212 rotates ADVERTISEMENT 1-ADVERTISEMENT N. For example, the advertisement position/reposition engine 212 animates a rotation sequence by moving ADVERTISEMENT 1 to the subordinate position occupied by ADVERTISEMENT N, and moves ADVERTISEMENT 2-ADVERTISEMENT N forward so that ADVERTISEMENT 2 occupies the prominent position. This repositioning can then be repeated. The particular graphics and repositioning implementation, such as animated repositioning or instantaneous repositioning, is a matter of design choice. The particular implementation of scaffolding symbology, such as a graphic and/or text, is also a matter of design choice.

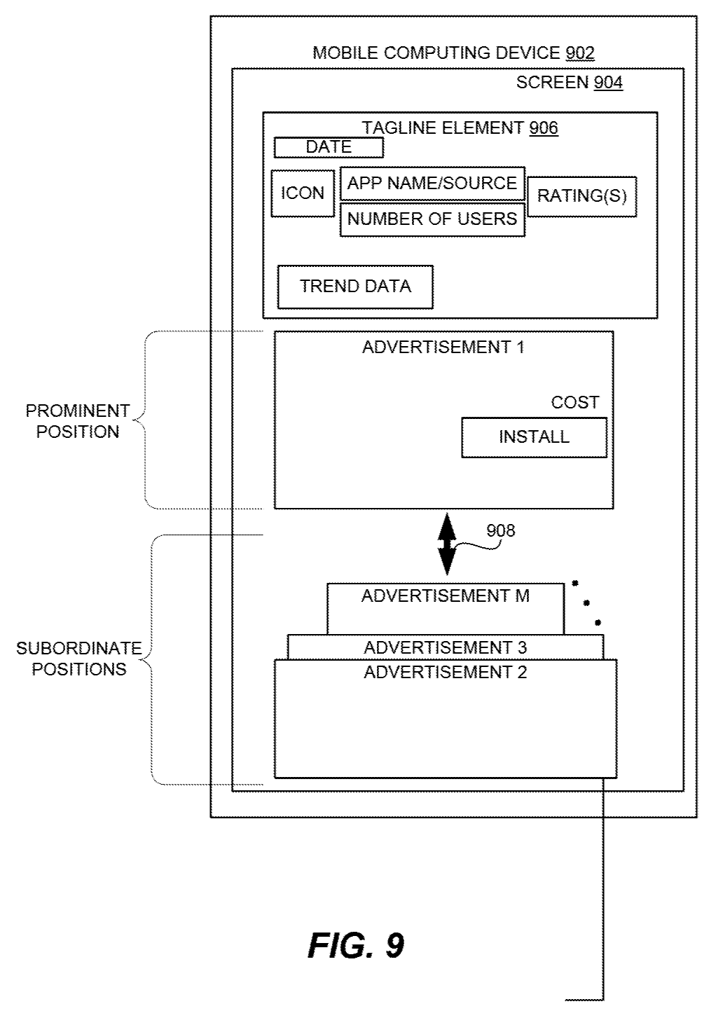

FIG. 9 depicts mobile computing device 902 represents one embodiment of mobile computing device 202 and includes screen 904, which represents one embodiment of screen 214. The displayed tagline element 906 includes multiple self-described data elements including DATE, ICON representing a particular app, APP NAME/SOURCE, NUMBER OF USERS, RATING(S), AND user TREND DATA. The advertisement position/reposition engine 212 transforms the screen 904 to display the tagline element 906 and M of N advertisements ADVERTISEMENT 1-ADVERTISEMENT M. “M” is an integer representing a number of concurrently displayed advertisements, and “N” is an integer greater than M representing a total number of advertisements available for display on screen 904. ADVERTISEMENT 1 occupies the prominent position, and ADVERTISEMENTS 2-M occupy subordinate positions. The scaffolding symbol 908 represents one embodiment of repositioning the ADVERTISEMENT 1-ADVERTISEMENT M. In at least one embodiment, the scaffolding symbol 808 serves as a visualized indication of how the advertisements will be repositioned and entices the user of mobile computing device 902 to interact with the scaffolding 908 and, thus, ADVERTISEMENT 1-ADVERTISEMENT M. In at least one embodiment, the scaffolding 808 can be selected by user interaction with the screen 804 to cause the advertisement position/reposition engine 212 to shuffle the ADVERTISEMENTS 1-M in order to reposition the advertisements. Thus, in at least one embodiment, when a user interacts with screen 804 and the interaction is detected and interpreted as a request to reposition ADVERTISEMENT 1-ADVERTISEMENT M, the advertisement position/reposition engine 212 shuffles ADVERTISEMENT 1-ADVERTISEMENT M. For example, the advertisement position/reposition engine 212 animates a shuffle sequence by moving ADVERTISEMENT 1 of the screen 904, moving ADVERTISEMENT 2 to the prominent position, moving ADVERTISEMENT 3-ADVERTISEMENT M forward, and inserting a new ADVERTISEMENT M+1 (not shown) to occupy the subordinate position occupied by ADVERTISEMENT M. This repositioning can then be repeated. The particular graphics and repositioning implementation, such as animated repositioning or instantaneous repositioning, is a matter of design choice. The particular implementation of scaffolding symbology, such as a graphic and/or text, is also a matter of design choice.

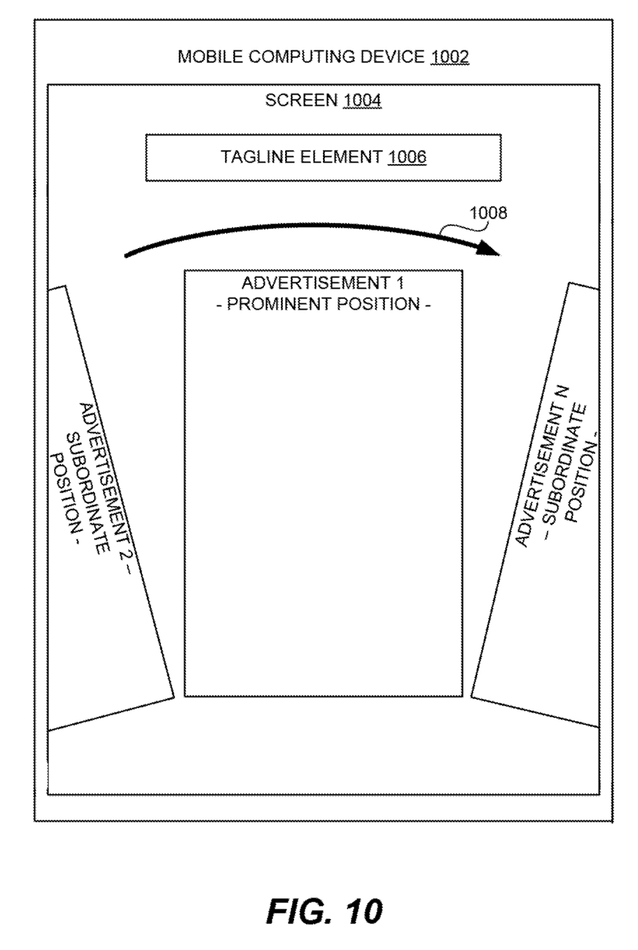

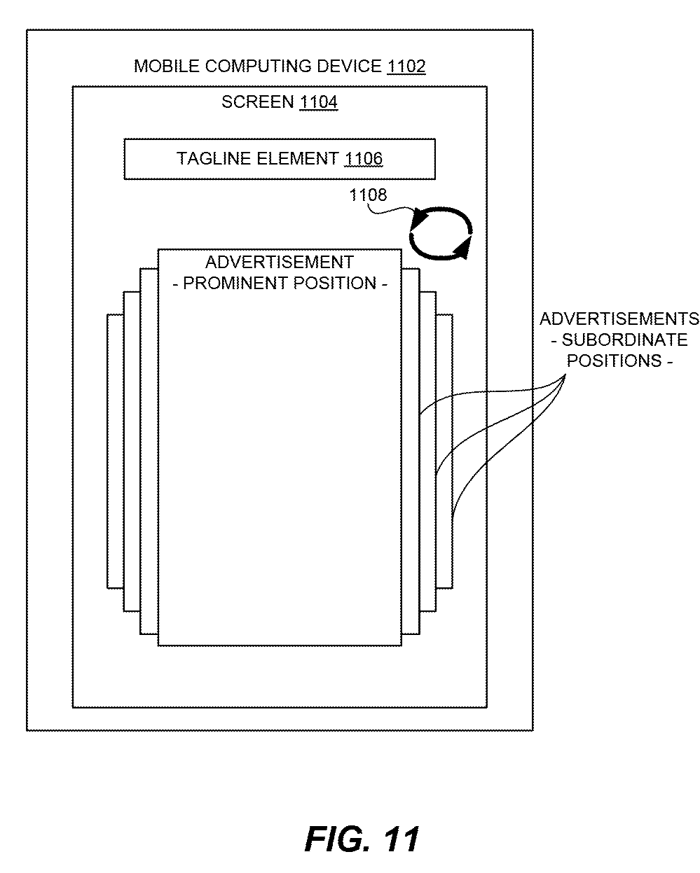

FIGS. 10 and 11 depict additional embodiments of respective mobile computing devices 1002 and 1102. The mobile computing devices 1002 and 1102 include respective screens 1004 and 1104 that display respective tagline elements 1006 and 1106 and scaffolding symbology 1008 and 1108. As previously discussed, the advertisement position/reposition engine 212 displays multiple advertisements ADVERTISEMENT 1-ADVERTISEMENT N and detects and interprets user interaction or an automated instruction to position and reposition ADVERTISEMENT 1-ADVERTISEMENT N. ADVERTISEMENT 1-ADVERTISEMENT N in FIG. 10 depict that positioning and repositioning of advertisements side-to-side along an arc path. ADVERTISEMENT 1-ADVERTISEMENT N in FIG. 11 depict that positioning and repositioning of advertisements in a front-to-back rotational shuffle.

Thus, a system and method transform a mobile computing device into a machine that displays multiple advertisements on a screen of the mobile computing device with at least one of the advertisements having a prominent position on a screen of the mobile computing device and the remaining, viewable advertisements having subordinate positions on the screen. Furthermore, the system and method further transform the mobile computing device into a machine that allows the user to reposition the advertisements by reallocating the prominent and subordinate positions to different advertisements.

Although embodiments have been described in detail, it should be understood that various changes, substitutions, and alterations can be made hereto without departing from the spirit and scope of the invention as defined by the appended claims.

What is claimed is:

1. An apparatus to transform a display of a mobile computing device, the apparatus comprising:
a processor;
a memory, coupled to the processor, the memory comprising code and data stored therein and the code is executable by the processor to transform the mobile computing device into a machine to:
display a first user interface on a screen of the mobile computing device;
receive advertising content, wherein the advertising content includes advertising content to display N advertisements, wherein N is an integer representing a quantity of advertisements included in the advertising content;
transform the first user interface into a second user interface, wherein to transform the first user interface comprises:
rendering the advertising content to display a first of the advertisements in a prominent position on the screen and to display second through M advertisements in subordinate positions relative to the first of the advertisements, wherein the prominent position occupies more screen space than any one subordinate position, wherein M is an integer greater than one and less than or equal to N;
(a) detect an interaction with the mobile computing device by a user;
(b) interpret the interaction to determine if the interaction indicates a request to reposition the advertisements that are displayed;
(c) when the interaction is interpreted to indicate the request to reposition the displayed advertisements, transform the second user interface into a third user interface that displays a repositioning of at least the M advertisements and repositions the advertisements to display a second of the N advertisements occupying the prominent position on the screen relative to the remaining advertisements; and
repeat (a)-(c) to transform a then-cunent user interface into a display that displays a repositioning of at least the M advertisements and repositions the advertisements to change which of the N advertisements occupies the prominent position on the screen relative to the remaining advertisements and which of the M advertisements occupies the subordinate positions.

2. The apparatus of claim 1 wherein to reposition the advertisements comprises to shuffle the advertisements and repositioning of at least the M advertisements comprises shuffling of at least the M advertisements

3. The apparatus of claim 1 wherein the prominent position is layered on top of the subordinate positions.

4. The apparatus of claim 1 wherein the code is executable by the processor to render the advertising content to display the advertisements as graphic cards.

5. The apparatus of claim 1 wherein the code is executable by the processor to include multiple modes of repositioning the advertisements, wherein the modes include one or more members of a group comprising: shuffling the advertisements from front to back, shuffling the advertisements from side-to side, and rotating the advertisements around one or more fixed points.

6. The apparatus of claim 1 wherein the prominent position is displayed above the subordinate positions.

7. The apparatus of claim 1 wherein M is less than N and, upon detection of an interaction with the mobile computing device by a user and interpretation of the interaction to indicate a request to reposition the advertisements that are displayed, to transform the then-current user interface the code is further executable by the processor to cause at least one of the N advertisements that was not displayed in the immediately preceding user interface to occupy a subordinate position.

8. The apparatus of claim 1 wherein the prominent position occupies at least 40% of the screen.

9. The apparatus of claim 1 wherein the code is executable by the processor to:
interpret the interaction to determine if the interaction indicates a selection of a displayed advertisement; and
when the interaction indicates a selection of a displayed advertisement:
sending a request for data to a server computer to retrieve data;
receiving the requested data; and
executing code included in the data received

10. The apparatus of claim 9 wherein the server computer comprises an advertisement selection and transmission engine.

11. The apparatus of claim 1 wherein the interaction with the mobile computing device by a user comprises at least one member of a group consisting of: a user swipe in contact with the screen of the mobile computing device, a user drag in contact with the screen of the mobile computing device, a user tap of the screen of the mobile computing device, a non-contact motion in proximity to the mobile computing device.

12. The apparatus of claim 1 wherein the code is executable by the processor to:
display trend data and tag line content of a product advertised in at least the advertisement in the prominent position.

13. The apparatus of claim 1 wherein the mobile computing device comprises a member of a group consisting of: a smart phone and a tablet computer.

14. A method to transform a display of a mobile computing device, the method comprising:
performing by a mobile computing device programmed with code stored in a memory and executing by a processor of the mobile computing device which transforms the mobile computing device into a machine to transform a display of a mobile computing device:
displaying a first user interface on a screen of the mobile computing device;
receiving advertising content, wherein the advertising content includes advertising content to display N advertisements, wherein N is an integer representing a quantity of advertisements included in the advertising content;
transforming the first user interface into a second user interface, wherein to transform the first user interface comprises:
rendering the advertising content to display a first of the advertisements in a prominent position on the screen and to display second through M advertisements in subordinate positions relative to the first of the advertisements, wherein the prominent position occupies more screen space than any one subordinate position, wherein M is an integer greater than one and less than or equal to N;
(a) detecting an interaction with the mobile computing device by a user;
(b) interpreting the interaction to determine if the interaction indicates a request to reposition the advertisements that are displayed;
(c) when the interaction is interpreted to indicate the request to reposition the displayed advertisements, transforming the second user interface into a third user interface that displays a repositioning of at least the M advertisements and repositions the advertisements to display a second of the N advertisements occupying the prominent position on the screen relative to the remaining advertisements; and
repeating (a)-(c) to transform a then-current user interface into a display that displays a repositioning of at least the M advertisements and repositions the advertisements to change which of the N advertisements occupies the prominent position on the screen relative to the remaining advertisements and which of the M advertisements occupies the subordinate positions.

15. The method of claim 14 wherein to reposition the advertisements comprises to shuffle the advertisements and repositioning of at least the M advertisements comprises shuffling of at least the M advertisements.

16. The method of claim 14 wherein the prominent position is layered on top of the subordinate positions.

17. The method of claim 14 wherein the method further comprises rendering the advertising content to display the advertisements as graphic cards.

18. The method of claim 14 wherein transforming the user interface includes multiple modes of repositioning the advertisements, wherein the modes include one or more members of a group comprising: shuffling the advertisements from front to back, shuffling the advertisements from side-to side, and rotating the advertisements around one or more fixed points.

19. The method of claim 14 wherein the prominent position is displayed above the subordinate positions.

20. The method of claim 14 wherein M is less than N and, upon detection of an interaction with the mobile computing device by a user and interpretation of the interaction to indicate a request to reposition the advertisements that are displayed, to transform the then-current user interface the code is further executable by the processor to cause at least one of the N advertisements that was not displayed in the immediately preceding user interface to occupy a subordinate position.

21. The method of claim 14 wherein the prominent position occupies at least 40% of the screen.

22. The method of claim 14 wherein the method further comprises:
interpret the interaction to determine if the interaction indicates a selection of a displayed advertisement; and
when the interaction indicates a selection of a displayed advertisement:
sending a request for data to a server computer to retrieve data;
receiving the requested data; and
executing code included in the data received.

23. The method of claim 9 wherein the server computer comprises an advertisement selection and transmission engine.

24. The method of claim 23 wherein the interaction with the mobile computing device by a user comprises at least one member of a group consisting of: a user swipe in contact with the screen of the mobile computing device, a user drag in contact with the screen of the mobile computing device, a user tap of the screen of the mobile computing device, a non-contact motion in proximity to the mobile computing device.

25. The method of claim 14 wherein the method further comprises:
displaying trend data and tag line content of a product advertised in at least the advertisement in the prominent position.

26. The method of claim 14 wherein the mobile computing device comprises a member of a group consisting of: a smart phone and a tablet computer.

27. An apparatus to provide display transforming code to a mobile computing device, the apparatus comprising:
a processor;
a memory, coupled to the processor, the memory comprising code and data stored therein and the code is executable by the processor to transform the mobile computing device into a machine to provide an application to a mobile computing device to transform a display of the mobile computing device, wherein the application includes code that is executable by the mobile computing device to:
display a first user interface on a screen of the mobile computing device;
receive advertising content, wherein the advertising content includes advertising content to display N advertisements, wherein N is an integer representing a quantity of advertisements included in the advertising content;
transform the first user interface into a second user interface, wherein to transform the first user interface comprises:
rendering the advertising content to display a first of the advertisements in a prominent position on the screen and to display second through M advertisements in subordinate positions relative to the first of the advertisements, wherein the prominent position occupies more screen space than any one subordinate position, wherein M is an integer greater than one and less than or equal to N;
(d) detect an interaction with the mobile computing device by a user;
(e) interpret the interaction to determine if the interaction indicates a request to reposition the advertisements that are displayed;
(f) when the interaction is interpreted to indicate the request to reposition the displayed advertisements, transform the second user interface into a third user interface that displays a repositioning of at least the M advertisements and repositions the advertisements to display a second of the N advertisements occupying the prominent position on the screen relative to the remaining advertisements; and
repeat (a)-(c) to transform a then-current user interface into a display that displays a repositioning of at least the M advertisements and repositions the advertisements to change which of the N advertisements occupies the prominent position on the screen relative to the remaining advertisements and which of the M advertisements occupies the subordinate positions.

28. A method comprising:
performing by a server computer programmed with code stored in a memory and executing by a processor of the server computer which transforms the server computer into a machine:
providing an application to a mobile computing device to transform a display of the mobile computing device, wherein the application includes code that is executable by the mobile computing device to:
display a first user interface on a screen of the mobile computing device;
receive advertising content, wherein the advertising content includes advertising content to display N advertisements, wherein N is an integer representing a quantity of advertisements included in the advertising content;
transform the first user interface into a second user interface, wherein to transform the first user interface comprises:
rendering the advertising content to display a first of the advertisements in a prominent position on the screen and to display second through M advertisements in subordinate positions relative to the first of the advertisements, wherein the prominent position occupies more screen space than any one subordinate position, wherein M is an integer greater than one and less than or equal to N;
(g) detect an interaction with the mobile computing device by a user;
(h) interpret the interaction to determine if the interaction indicates a request to reposition the advertisements that are displayed;
(i) when the interaction is interpreted to indicate the request to reposition the displayed advertisements, transform the second user interface into a third user interface that displays a repositioning of at least the M advertisements and repositions the advertisements to display a second of the N advertisements occupying the prominent, position on the screen relative to the remaining advertisements; and
repeat (a)-(c) to transform a then-current user interface into a display that displays a repositioning of at least the M advertisements and repositions the advertisements to change which of the N advertisements occupies the prominent position on the screen relative to the remaining advertisements and which of the M advertisements occupies the subordinate positions.
